(19) United States
(12) Patent Application Publication
(10) Pub. No.: US 2010/0243416 A1
(43) Pub. Date: Sep. 30, 2010

(54) ILLUMINATED KEYPAD

(75) Inventors: Chung Muh Fong, Bukit Jambul (MY); Lee Sian Tatt, Georgetown (MY); Ko Choon Guan, Sungai Dua (MY); Ng Fook Chuin, Taman Bayu (MY)

Correspondence Address: Kathy Manke;Avago Technologies Limited, 4380 Ziegler Road, Fort Collins, CO, 80525, US

(73) Assignee: Avago Technologies ECBU IP (Singapore) Pte. Ltd.

(21) Appl. No.: 12/413,484

(22) Filed: Mar. 27, 2009

(51) Int. Cl. H01H 9/00

(52) U.S. Cl. 200/310

(57) ABSTRACT

Illuminated keypads are disclosed herein. One embodiment includes first and second light guides having a compressible material located therebetween. The material blocks light from traveling between the light guides.

### BACKGROUND

Many keypads have lights located therein that enable keys to be illuminated. The keys may contain icons or numbers that guide the user to make selections between different keys. Therefore, some keys need to be illuminated while some keys are not illuminated. Problems exist when light from an illuminated key leaks to a key that should be not be illuminated. The key that is not illuminated becomes illuminated by way of the leaked light.

### BRIEF DESCRIPTION OF THE DRAWINGS

FIG. 1 is a plan view of an embodiment of a keypad.

FIG. 2 is a side cutaway view of an embodiment of the keypad of FIG. 1.

### DETAILED DESCRIPTION

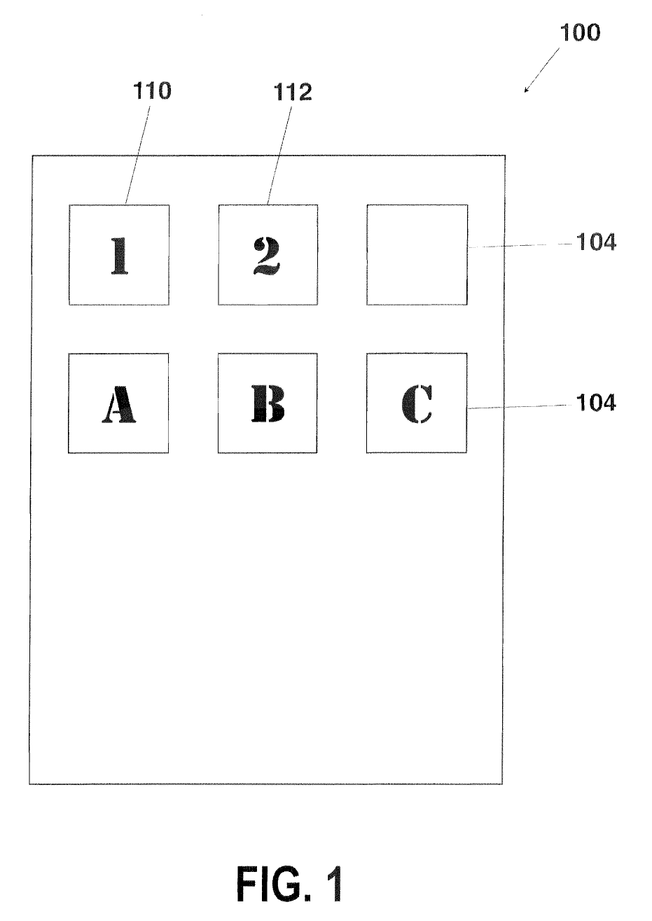

A top plan view of an embodiment of a keypad is shown in FIG. 1. The keypad 100 contains several portions 104, wherein each portion may be an area of the keypad 100 that is able to be pressed. The portions 104 may be keys on the keypad, but for illustration purposes, they are referred to as portions 104 of the keypad 100. For example, the portions 104 may be numbers or icons on the keypad 100 that are depressable. As described in greater detail below, the portions 104 may be individually illuminated.

Reference is made to a first portion 110 and a second portion 112. It is noted that the first portion 110 and the second portion 112 may be substantially similar to the other portions 104 of the keypad 100. The portions 104 may be individually illuminated. For example, the first portion 110 may be illuminated during a period when the second portion 112 is not and should not be illuminated. The illumination of different portions 104 may be used to offer the user of the keypad 100 options to depress illuminated portions of the keypad 100. In conventional illuminated keypads, light from one portion may leak to another portion that should not be illuminated. This leakage causes the other portion to illuminate when it should not. The keypad 100 described herein overcomes the light leakage problem so that only portions of the keypad 100 that are intended to illuminate actually illuminate.

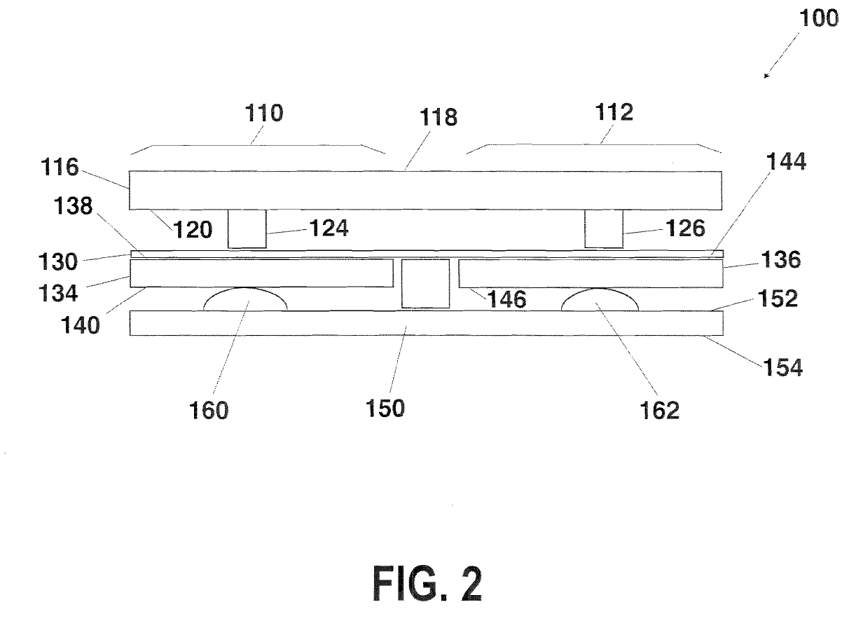

A side cutaway view of the keypad 100 of FIG. 1 is shown in FIG. 2. The first portion 110 and the second portion 112 are shown as bracketed regions. The first portion 110 and the second portion 112 may refer to illuminated keys on the keypad 100. Pressing either the first portion 110 or the second portion 112 will cause a switch to activate as described in greater detail below.

The keypad 100 has an outer layer 116 that is made from a flexible material. The flexible material means that it can be depressed so as to operate a switch or the like described herein and return to its original configuration without being permanently deformed. The first layer has a first surface 118 and a second surface 120 located opposite of the first surface 118. The first surface 118 corresponds to the side of the keypad 100 that is viewed and operated by a user. The outer layer 116 may pass light between the first surface 118 and the second surface 120. Icons or the like may be located in or on the outer layer 116 so as to be illuminated by the light. The light is sometimes referred to as reacting with the icons.

A plurality of protrusions may extend from the second side 120 of the outer layer 116. As described in greater detail below, the protrusions may facilitate operation of the switches. In some embodiments, each portion 110, 112 of the outer layer 116 has at least one protrusion associated therewith. In the embodiment of FIG. 2, the first portion 110 of the outer layer 116 has a first protrusion 124 extending from the second surface 120. The second portion 112 of the outer layer 116 has a second protrusion 126 extending from the second surface 120. In some embodiments, the protrusions 124, 126 are made of the same material as the outer layer 116.

In some embodiments, a light guide holder 130 extends between at least the first portion 110 and the second portion 112. The light guide holder 130 may be made of transparent material and may serve to hold the light guides in place as described below.

Each portion of the keypad 100 that is to be illuminated may have a light guide associated with it. In the view of FIG. 2, two light guides are shown and are referred to individually as a first light guide 134 and a second light guide 136. The first light guide 134 has a first light guide first surface 138 and a first light guide second surface 140, which are opposite one another. Likewise, the second light guide 136 has a second light guide first surface 144 and a second light guide second surface 146, which are opposite one another. Although the light guides 134, 136, the light guide holder 130, and the protrusions 124, 126 are shown as not contacting each other in FIG. 2, they may contact each other.

The keypad 100 has a substrate 150, which may be a circuit board or the like. Electrical connections and devices may be located on the substrate 150. The substrate 150 has a first side 152 and an opposite second side 154. The first side 152 of the substrate 150 faces the second surfaces 140, 146 of the first light guide 134 and the second light guide 136. Switches 160, 162 may be located on the first side 152 of the substrate 150. A first switch 160 is located in the first portion 110. A second switch 162 is located in the second portion 112. The switches 160, 162 may be metal type switches or may have compressible domes located thereon as shown in FIG. 2. Conductors within the domes may contact electrical contacts on the first side 152 when the domes are depressed.

A space exists between the first light guide 134 and the second light guide 136. In order to prevent light from leaking between the first and second light guides 134, 136, a compressible material 170 is located in the space. The compressible material 170 may be located in the light paths extending between the first light guide 134 and the second light guide 136 in order to prevent light from leaking between the light guides 134, 136. The compressible material 170 may extend from the substrate 150 to the light guide holder 130 or to the first surfaces 138, 144 of the light guides 134, 136.

In some embodiments, the compressible material 170 contains urethane. In still other embodiments, the compressible material 170 is a closed cell material or a closed cell foam material. In some embodiments, the compressible material is black so as to prevent light from reflecting off the compressible material 170. A compressible material means that it is able to be compressed as used in the keypad 100 and substantially return to its original shape with insignificant permanent deformation.

Having described the components of the illuminated keypad 100, its operation will now be described. A processor or other device (not shown) determines which portions 104 of the keypad 100 are to be illuminated. The processor or other device may then cause a light source (not shown) to illuminate a light guide 134, 136 that correspond to the portions 104 of the keypad 100 that are to be illuminated. In this example, the first portion 110 of the keypad corresponding to the first light guide 134 is to be illuminated and the second portion 112 of the keypad 100 corresponding to the second light guide 136 is not to be illuminated.

Light from the illuminated first light guide 134 passes through the light guide holder 130 and to the second side 120 of the outer layer 116. As described above, icons may be present in the outer layer 116 (or in other sections of the keypad 100) so that the light reacts with the icons as it passes to the first side 118 of the outer layer 116. The result is that the icon is illuminated on the first portion 110 of the keypad 100. In other embodiments, the icon may be present in the light guide holder 130 or in the first light guide 134. In other embodiments, there are not icons.

The compressible material 170 prevents light emitted from the first light guide 134 from entering the second light guide 136. Therefore, the second portion 112 of the keypad 100 will remain without illumination.

A user may depress the first portion 110 of the keypad 100. This depressing causes the first protrusion 124 to apply pressure to the components of the keypad 100 and deform the switch 160. Thus, the switch 160 is toggled. During the application of pressure to the first portion 110, some deformation may occur in the region of the compressible material 170. Because the material is compressible, it maintains its light blocking characteristics during compression. The result is that no light leaks to the second light guide 136 during the period when the first portion 110 is being depressed. When pressure is removed from the first portion 110, the first switch 160 and the other components of the keypad 100 return to their original shape. The same applies to the compressible material 170. More specifically, the compressible material 170 returns to its original configuration, which continues to prevent light leakage to the second light guide 136 even after compression of the first portion 110.

What is claimed is:

1. An illuminated keypad comprising:
an outer layer comprising a first portion and a second portion, wherein said first portion and said second portion are depressable, said outer layer comprising an outer layer first side and an outer layer second side;
a first light guide having a first light guide first surface and a first light guide second surface, wherein said first light guide first surface is located adjacent said outer layer second side proximate said first portion;
a second light guide having a second light guide first surface and a second light guide second surface, wherein said second light guide first surface is located adjacent said outer layer second side proximate said second portion;
a substrate extending at least between said first light guide second side and said second light guide second side;
a first switch attached to said substrate and located proximate said first light guide second surface;
a second switch attached to said substrate and located proximate said second light guide second surface;
a space between said first light guide and said second light guide; and
a compressible material located in said space in the light paths between said first light guide and said second light guide.

2. The keypad of claim 1 and further comprising a light guide holder located between said outer material second surface and said first light guide first surface.

3. The keypad of claim 1 and further comprising a light guide holder extending between at least said first light guide first surface and said second light guide first surface.

4. The keypad of claim 1 and further comprising a light guide holder extending between at least said first light guide first surface and said second light guide first surface, wherein said compressible material extends between said substrate and said light guide holder.

5. The keypad of claim 1, wherein said compressible material is a closed cell material.

6. The keypad of claim 1, wherein said compressible material comprises urethane.

7. The keypad of claim 1, wherein said compressible material is black.

8. The keypad of claim 1, wherein said compressible material is a foam material.

9. The keypad of claim 1, wherein said first switch comprises a metal dome extending from said substrate.

10. The keypad of claim 1, wherein an icon is located on said outer layer in said first portion and wherein light emitted by said first light guide reacts with said icon.

11. The keypad of claim 1, wherein at least some light emitted by said first light guide passes through at least a portion of said first portion of said outer layer.

12. The keypad of claim 1 and further comprising first protrusion extending from said outer layer second side in the proximity of said first portion.

13. An illuminated keypad comprising:
an outer layer comprising a first portion and a second portion, wherein said first portion and said second portion are depressable, said outer layer comprising an outer layer first side and an outer layer second side;
a first light guide having a first light guide first surface and a first light guide second surface, wherein said first light guide first surface is located adjacent said outer layer second side proximate said first portion;
a first protrusion extending from said outer layer second side proximate said first portion;
a second light guide having a second light guide first surface and a second light guide second surface, wherein said second light guide first surface is located adjacent said outer layer second side proximate said second portion;
a second protrusion extending from said outer layer second side proximate said second portion;
a light guide holder extending between at least said first protrusion and said second protrusion;
a substrate extending at least between said first light guide second side and said second light guide second side;
a first switch attached to said substrate and located proximate said first light guide second surface;
a second switch attached to said substrate and located proximate said second light guide second surface;
a space between said first light guide and said second light guide; and
a compressible material located in said space in the light paths between said first light guide and said second light guide.

14. The keypad of claim 13, wherein said compressible material is a closed cell material.

15. The keypad of claim 13, wherein said compressible material comprises urethane.

16. The keypad of claim 13, wherein said compressible material is black.

17. The keypad of claim 13, wherein said compressible material is a foam material.

18. The keypad of claim 13, wherein said first switch comprises a metal dome extending from said substrate.

19. The keypad of claim 13, wherein an icon is located on said outer layer in said first portion and wherein light emitted by said first light guide reacts with said icon.
